(19) United States
(12) Patent Application Publication
(10) Pub. No.: US 2012/0194178 A1
(43) Pub. Date: Aug. 2, 2012

(54) ROTOR FOR ROTATION SENSOR

(76) Inventor: Shinzaburo ICHIMAN, Okayama (JP)

(21) Appl. No.: 13/445,158

(22) Filed: Apr. 12, 2012

Related U.S. Application Data
(63) Continuation of application No. 12/878,511, filed on Sep. 9, 2010, now abandoned.
Application No. 12/878,511 is a continuation of application No. 12/486,306, filed on Jun. 17, 2009, now abandoned.
Application No. 12/486,306 is a continuation of application No. 12/061,310, filed on Apr. 2, 2008, now abandoned.
Application No. 12/061,310 is a continuation of application No. 11/822,245, filed on Jul. 3, 2007, now abandoned.
Application No. 11/822,245 is a continuation of application No. 11/581,577, filed on Oct. 17, 2006, now abandoned.
Application No. 11/581,577 is a continuation of application No. 11/369,745, filed on Mar. 8, 2006, now abandoned.
Application No. 11/369,745 is a continuation of application No. 10/107,373, filed on Mar. 28, 2002, now abandoned.

(30) Foreign Application Priority Data
Mar. 28, 2001 (JP) 2001-092894

(51) Int. Cl. G01B 7/30

(52) U.S. Cl. 324/207.25

(57) ABSTRACT

A rotor for a rotation sensor may be mounted on a bearing that supports a wheel on an automotive vehicle so that it can detect the number of revolutions for the wheel. The rotor for a rotation sensor 1 includes a reinforcing ring 2 formed like an L-shape in cross section, including a cylindrical part 3 adapted to be fitted on a peripheral surface of the rotating part of the bearing (inner race or outer race) and a flanged part 4 bent at an end edge of the cylindrical part 3, from which it extends in the radial direction. A multi-pole magnet 10 is attached to the axial outer lateral side of the flanged part 4, and a non-magnetic covering 6 encloses the axial outer lateral side of the multi-pole magnet 10 and has a peripheral edge on its one end secured to the reinforcing ring 2.

This is a continuation of U.S. patent application Ser. No. 12/878,511, filed Sep. 9, 2010, which is a continuation application of U.S. patent application Ser. No. 12/486,306, filed Jun. 17, 2009, now abandoned, which is a continuation application of U.S. patent application Ser. No. 12/061,310, filed Apr. 2, 2008, now abandoned, which is a continuation application of U.S. patent application Ser. No. 11/822,245, filed Jul. 3, 2007, now abandoned, which is a continuation application of U.S. patent application Ser. No. 11/581,577, filed Oct. 17, 2006, now abandoned, which is a continuation application of U.S. patent application Ser. No. 11/369,745, filed Mar. 8, 2006, now abandoned, which is a continuation of U.S. patent application Ser. No. 10/107,373, filed Mar. 28, 2002, now abandoned.

### BACKGROUND OF THE INVENTION

1. Field of the Invention

The present invention relates generally to a rotation detecting device that may be mounted on a bearing that supports a wheel on an automotive vehicle, and may be used for detecting the number of revolutions for the wheel supported by the bearing and rotating relative to the bearing, and more particularly to a rotor for a rotation sensor that is designed for use on an automotive vehicle on which an anti-lock braking system (ABS) and/or traction control system (TCS) is installed in order to detect the number of revolutions for each of the front and rear wheels.

2. Description of the Prior Art

Typically, a conventional rotation detecting device has the following construction. The rotation detecting device is mounted on each of the wheels on an automotive vehicle for detecting the number of revolutions for each respective wheel, thereby detecting whether differences in the revolutions between those wheels occurs. In most cases, the rotation detecting device typically includes a rotor for the rotation sensor that is mounted on a rotating part of a bearing (inner or outer race), and a pulse-sensitive sensor that is responsive to pulses emitted by the rotor for the rotation sensor. The rotor for the rotation sensor, which provides pulses, each of which represents the number of revolutions for a particular wheel, typically comprises a reinforcing ring formed like an L-shape in cross section. The reinforcing ring includes a cylindrical part rigidly fitted on the peripheral surface of the rotating part of the bearing and a round ring part bent at the end edge of the cylindrical part, from which it extends in the radial direction. A pulse generator means comprises a multi-pole magnet arranged on an axial outer lateral side of the round ring part of the reinforcing ring. The pulse generator means may produce pulses, which represent the number of revolutions for the wheel on which it is mounted, and the pulse-sensitive sensor that is responsive to those pulses from the pulse generator means may be mounted from the outside along the axial direction so that it may be located close to the pulse generator means, facing opposite the pulse generator means. This type of rotation detecting device is now developed, and has actually been used for practical purposes.

In most cases, this rotation detecting device further includes a seal lip that is formed on the end of the reinforcing ring. This seal lip adds a sealing function for the device. To provide an easy understanding of the rotation detecting device according to the prior art, its construction is described below in further detail by referring to FIG. 13.

A typical example of the conventional rotation detecting device is shown in FIG. 13. As shown in FIG. 13, a cylindrical part 104 of a reinforcing ring 103 is rigidly fitted on a peripheral surface of a rotating part of a bearing (the peripheral surface of a outer race 101 in the example shown in FIG. 13). The reinforcing ring 103 includes a round ring part 105 bent at the end edge of the cylindrical part 104 and from which it extends in the radial direction thereof. A pulse generating means, which has the form of a pulse generating ring shown as 106, comprises a multi-pole magnet that is mounted on the axial outer lateral side of the round ring part 105. A rotation detecting sensor 108, which is responsive to pulses from the pulse generating ring 106, may be mounted from the outside along the axial direction thereof, so that it may be located close to the location of the pulse generating ring 106 and facing opposite the pulse generating ring 106.

More specifically, the reinforcing ring 103 is formed like an L-shape in cross section, including the cylindrical part 104 and the round ring part 105 bent at the end edge of the cylindrical part 104 and from which it extends toward the radial direction thereof. The reinforcing ring 103 further includes a seal lip 107 as shown in FIG. 13, which is formed on the end of the reinforcing ring 103. The seal lip 107 makes sliding contact with the peripheral surface of the inner race 102 of the bearing. It provides a sealing function that protects the bearing against any external liquids or solids that might otherwise enter the outer race 101 and inner race 102 of the bearing.

In the prior art rotation detecting device that includes the pulse generating rotor that acts as the rotor for the rotation sensor as shown in FIG. 13, the pulse generating ring 106 is placed close to the rotation detecting sensor 108, and is located on the outermost side where it is always exposed to the atmosphere. The pulse generating ring 106 is thus placed in unfavorable conditions under which it might directly be exposed to any splashing water or extraneous solids. If any water, for example, should enter the pulse generating ring 106, it would produce rust that may be built up on the pulse generating ring 106. If this occurs, the pulse generating ring 106 might reduce its rotation detecting capability. In worse cases, if any extraneous solids should enter the pulse generating ring 106, they might be built up on every part of the pulse generating ring 106. If such extraneous solids should enter the area between the pulse generating ring 106 and rotation detecting sensor 108, and should be built up on that area, they might be caught by the pulse generating ring 106 while it is rotating. If this occurs, the pulse generating ring 106 would be damaged. If the pulse generating ring 106 should be damaged, it would not be able to function properly. Thus, the pulse generating ring 106 would not be able to provide pulses that reflect an accurate number of revolutions. This presents a fatal defect to the rotation detecting device.

### SUMMARY OF THE INVENTION

The present invention addresses the problems associated with the rotor for the rotation sensor that is included in the prior art rotation detecting device, as described in the preceding section. In order to solve those problems, a principal object of the present invention is to provide a rotor for the rotation sensor that provides for an increased sensing capability and mechanical durability by protecting the pulse generating part completely against any possible external factors that might adversely affect the pulse generating part.

In order to achieve the above object, the present invention proposes to provide a rotor for the rotation sensor that may be mounted on a bearing that supports each of the wheels on an automotive vehicle so that it can detect the number of revolutions for each respective wheel supported by the bearing. More specifically, the rotor for the rotation sensor according to the present invention comprises a reinforcing ring formed like an L-shape in cross section. The reinforcing ring includes a cylindrical part rigidly fitted on the peripheral surface of the rotating part of the bearing and a flanged part bent at an end edge of the cylindrical part from which it extends in the radial direction thereof. A multi-pole magnet is arranged on the axial outer lateral side of the flanged part, and a non-magnetic covering, having its peripheral edge on one end secured to the reinforcing ring, encloses the axial outer lateral side of the multi-pole magnet.

Briefly, the rotor for the rotation sensor according to the present invention has the construction that is described below. It may be appreciated from the following description that the rotor for the rotation sensor of the present invention has several advantages over the corresponding prior art construction. Specifically, a reinforcing ring 2 includes a cylindrical part 3 that is adapted to be rigidly fitted on the rotating part of the bearing (which corresponds to the inner race 102 in FIG. 1 and FIGS. 5 through 9, or the outer race 101 in FIG. 4) and a flanged part 4 bent at an end edge of the cylindrical part 3 from which it extends in the radial direction thereof. The multi-pole magnet 10, which provides pulses that represent the number of revolutions, is disposed on an axial outer lateral side of the flanged part 4. The multi-pole magnet 10 has its axial outer lateral side enclosed by a non-magnetic covering 6. This covering 6 has its peripheral edge on one end secured to the reinforcing ring 2. The covering 6, the reinforcing ring 2 and the multi-pole magnet 10 have a sandwich arrangement, wherein the covering 6 is located on the axial outer lateral side of the multi-pole magnet 10, and has its peripheral edge on one end secured to the reinforcing ring 2. The multi-pole magnet 10 is held between the covering 6 and the flanged part 4 of the reinforcing ring 2. Those three components are thus combined into a single unit. As the multi-pole magnet 10 has its axial outer lateral side enclosed by the covering 6, it will not be affected by any external factors.

In the preceding description, the covering 6 may be made of any non-magnetic material that allows the magnetic force to be transmitted easily through the covering 6.

This ensures that the multi-pole magnet 10 can retain its capability of producing pulses. More specifically, the multi-pole magnet 10 can be protected against any extraneous liquids or solids, such as pebbles, sands, mud, water and the like, which might come from the outside. Any wear or damage that would otherwise be caused by such extraneous liquids or solids can be prevented. Thus, the multi-pole magnet 10 can keep on functioning properly, and can thus produce pulses that accurately reflect the number of revolutions.

It should be noted that any type of encoder that is actually used in this field may be employed as the multi-pole magnet 10. For example, the multi-pole magnet may be obtained by following the steps that are described below. Any synthetic rubber or other synthetic resin-based elastic material is provided, to which any ferromagnetic material may be added. The mixture resulting from mixing them together may be placed in a mold where it may be vulcanized and shaped. Then, the resulting shape may be magnetized so that it can have S poles and N poles, each S pole and each N pole appearing alternately around the circumference thereof. Finally, the multi-pole magnet 10 may thus be obtained. This multi-pole magnet 10 may be attached to the axial outer lateral side of the flanged part 4 of the reinforcing ring 2 by means of any suitable adhesive or the like. Alternatively, the multi-pole magnet 10 may take a different form. In this alternative form, the multi-pole magnet 10 may be obtained in the following manner. That is, a preliminary base treatment may first occur against the axial outer lateral side of the flanged part 4 of the reinforcing ring 2, and any suitable adhesive may then be applied onto that axial outer lateral side. Then, the rubber material that contains the ferromagnetic material may be placed together with the reinforcing ring 2 within the mold, where the rubber material may be vulcanized and formed into the shape of a multi-pole magnet, which is now attached to the axial outer lateral side of the flanged part 4. The multi-pole magnet, which is not still magnetized, may then be magnetized to provide alternate S poles and N poles. Finally, the multi-pole magnet 10 may thus be obtained.

In the preceding description, the covering 6 may be secured to the reinforcing ring 2 by deforming the marginal edge 7 of the covering 6 on its one end by swaging that marginal edge 7.

For example, as shown in FIGS. 1 and 2, the covering 6 may be secured to the reinforcing ring 2 by deforming partly the marginal edge 7 of the covering 6 facing a radial peripheral edge 5 of the flanged part 4 of the reinforcing ring 2 by swaging that marginal edge 7.

In securing the covering 6 to the reinforcing ring 2 by swaging the marginal edge 7 of the covering 6, the swaging can occur with ease if the marginal edge 7 of the covering 6 is made thinner as shown in FIG. 10. In this way, the covering 6 can be secured to the reinforcing ring 2 by deforming the thinner marginal edge 17 by swaging it, as indicated by an arrow 20 in FIG. 10. This can occur with accuracy without affecting the remaining parts of the covering 6 and/or the reinforcing ring 2. Alternatively, the covering 6 may be provided with slits 21 at regular intervals around the marginal edge 7 thereof, as shown in FIG. 11. This may also provide a effective means of swaging the marginal edge 7. That is, those slits 21 may reduce the rigidity, which makes the bending easier by swaging the marginal edge 7 as indicated by the arrow 20.

Although this is not shown, the covering 6 may be secured to the reinforcing ring 2 by partly deforming the radial peripheral edge 5 of the flanged part 4 of the reinforcing ring 2 by swaging that edge 5.

It may be seen from FIGS. 3 and 4 that the covering 6 may be provided with elastic projections 9, 19, which may be formed on the marginal edge 7 of the covering 6 facing opposite the radial peripheral edge 5 of the flanged part 4 of the reinforcing ring 2. In this case, the covering 6 may be secured to the reinforcing ring 2 by forcing the radial peripheral edge 5 of the flanged part 4 of the reinforcing ring 2 into the elastic projections 9, 19. This may provide the swaging effect in an elastic manner.

In any of the embodiments shown in FIGS. 1, 2, 3, and 4, it may be appreciated that the covering 6, which is located on the axial outer lateral side of the multi-pole magnet 10, is secured to the reinforcing ring 2 by swaging the peripheral edge of the covering 6 on its one end. Thus, the covering 6, the multi-pole magnet 10, and the flanged part 4 of the reinforcing ring 2 may have the sandwich arrangement wherein the multi-pole magnet 10 is held between the flanged part 4 and the covering 6. Those three components are thus combined together into a single unit. This avoids the multi-pole magnet 10 being removed from the axial outer lateral side of the flanged part 4 or sliding away therefrom. This ensures that the rotation detecting sensor provides it's a high-precision rotation detecting capability which can be maintained for a long-term period.

In one aspect of the present invention shown from FIG. 5, the rotor for the rotation sensor may be constructed such that the covering 6 is secured to the reinforcing ring 2 at one end thereof, with a other end 8 opposite the one end extending up to the location of an end edge 51 of the multi-pole magnet 10 located on the side of the cylindrical part 3 and terminating at that location. This construction ensures that the axial outer lateral side of the multi-pole magnet 10 that faces opposite the rotation detecting sensor 108 located close to the multi-pole magnet 10 may be covered by the covering 6. The axial outer lateral side of the multi-pole magnet 10 can be protected from any external influences that are coming in the axial direction.

In another aspect of the present invention shown in FIG. 6, the rotor for the rotation sensor may be constructed such that the covering 6 is secured to the reinforcing ring 2 at one end thereof, with its other end 8 opposite the one end extending beyond the end edge 51 of the multi-pole magnet 10 located on the side of the cylindrical part 3 toward the cylindrical part 3. A gap 52 is created between the other end 8 of the covering 6 and the axial outer lateral side of the flanged part 4. This construction ensures that the end of the multi-pole magnet 10 located on the side of the cylindrical part 3 may also be protected, as compared with the construction shown in FIG. 5. Also, as compared with the construction shown in FIG. 5, the construction shown in FIG. 6 may eliminate the need of terminating the end 8 of the covering 6 at the location of the end edge 51 of the multi-pole magnet 10. This construction can allow the rotor for the rotation sensor to be manufactured with the required precision and accuracy, making it easier to manufacture the rotor for the rotation sensor.

In a further aspect of the present invention shown in FIG. 7, the rotor for the rotation sensor may be constructed such that the covering 6 is secured to the reinforcing ring 2 at one end thereof, with its other end 8 opposite the one end extending beyond the end edge 51 of the multi-pole magnet 10 located on the side of the cylindrical part 3 toward the cylindrical part 3. A gap 52 is created between the other end 8 of the covering 6 and the axial outer lateral side of the flanged part 4, and a bent portion 53 is formed on the other end 8 of the covering 6. This construction may have the features of the construction of FIG. 6, and may additionally increase the mechanical rigidity of the covering 6. It may also be seen from FIG. 7 that the bent portion 53 is formed on the other end 8 of the covering 6 so that it can extend inwardly and axially just below the end edge 51 of the multi-pole magnet 10 located on the side of the cylindrical part 3. The bent portion 53 is provided for engaging the end edge 51 of the multi-pole magnet 10 when the covering 6 is placed in position, and may aid in positioning the covering 6 accurately.

It should be noted that the shape of the bent portion 53 is not limited to that shown in FIG. 7, but the bent portion 53 may take any shape that can contribute to increased rigidity of the covering 6.

In still another aspect of the present invention shown in FIG. 8, the rotor for the rotation sensor may be constructed such that the covering 6 is secured to the reinforcing ring 2 at one end thereof, with its other end 8 opposite the one end extending beyond the end edge 51 of the multi-pole magnet 10 located on the side of the cylindrical part 3 toward the cylindrical part 3. The other end 8 may be bent toward the side of the flanged part 4.

As compared with the construction shown in FIG. 6, the construction shown in FIG. 8 ensures that the end of the multi-pole magnet 10 located on the side of the cylindrical part 3 can be protected from the outside.

In another aspect of the present invention shown in FIG. 9, which corresponds to a variation of the construction shown in FIG. 8, the rotor for the rotation sensor may be constructed such that the covering 6 is secured to the reinforcing ring 2 at one end thereof, with its other end 8 opposite the one end extending beyond the end edge 51 of the multi-pole magnet 10 located on the side of the cylindrical part 3. The other end 8 may be bent toward the side of the flanged part 4. A gap 54 may be created on the axial outer lateral side of the flanged part 4. As shown in FIG. 9, the gap 54 is delimited by the axial outer lateral side of the flanged part 4, the end edge 51 of the multi-pole magnet 10 located on the side of the cylindrical part 3, and the bent portion of the other end of the covering 6.

As compared with the construction shown in FIG. 8, the construction shown in FIG. 9 permits the other end 8 of the covering 6 to be bent more freely toward the side of the flanged part 4, and permits the rotor for the rotation sensor to be manufactured with the required precision and accuracy, making it easier to manufacture the rotor for the rotation sensor.

In a further aspect of the present invention shown in FIG. 1, which corresponds to one variation of each of the embodiments described above, the rotor for the rotation sensor may be constructed such that the covering 6 is secured to the reinforcing ring 2 at one end thereof, with its other end 8 opposite the one end extending beyond the end edge 51 of the multi-pole magnet 10 located on the side of the cylindrical part 3. Covering 6 includes a lip 11 extending from the other end 8 in the radial direction and formed to have a tip that is adapted to engage the peripheral surface of the bearing on which the cylindrical part 3 is fitted.

In a still further aspect of the present invention shown in FIG. 4, which corresponds to another variation of each of the embodiments described above, the rotor for the rotation sensor may be constructed such that the covering 6 is secured to the reinforcing ring 2 at one end thereof, wherein the marginal edge 7 on the one end of the covering 6 includes a lip 12 that is formed to extend from the marginal edge 7 in the radial direction. The lip 12 has a tip adapted to engage the peripheral surface of the bearing opposite the peripheral surface of the bearing on which the cylindrical part 3 is fitted. In the construction shown in FIG. 4, the cylindrical part 3 of the reinforcing ring 2 may be fitted on the outer race 101 of the bearing, while the tip of the lip 12, which is formed to extend from the marginal edge 7 in the radial direction, may engage the peripheral surface of the inner race 102.

In the embodiments described above, where the lips 11 and 12 are provided, the lips may be formed from any elastic material, such as synthetic rubber. This may provide the increased sealing function.

In each of the embodiments described so far, the covering 6 may have a thickness of between 0.1 mm and 0.6 mm.

When the covering 6 has such small thickness as indicated above, it may allow the magnetic forces to be transmitted more easily through the covering 6. It may also allow the marginal edge 7 of the covering 6 on its one end to be secured to the reinforcing ring 2 with ease and with accuracy by swaging that edge 7.

The covering 6 may be made of any non-magnetic materials that can meet the requirements for the functional performance and mechanical rigidity as described above, and such non-magnetic materials may include SUS 304, Al, CuZn, Cu and the like, for example.

It may be appreciated that the rotor for the rotation sensor according to each of the embodiments described above includes the reinforcing ring 2, multi-pole magnet 10 and covering 6 that have the sandwich construction, wherein the multi-pole magnet 10 is held between the flanged part 4 of the reinforcing ring 2 and the covering 6 and the components are assembled together into a single unit. In the embodiments, the components may be formed separately as shown in FIG. 12, and the separate components may be assembled together by securing the covering 6 to the flanged part 4 of the reinforcing ring 2 by swaging the appropriate part as indicated by the dashed lines in FIG. 2, after the multi-pole magnet 10 has been magnetized.

It should be understood that as a variation of any of the embodiments described above, the reinforcing ring 2 and the multi-pole magnet 10 may be provided as an integral unit, or may be provided separately and then combined into a single unit by using any suitable adhesive. In either case, the unit may be secured to the covering 6 by swaging the appropriate part. Which of the embodiments should be chosen may be determined, depending upon the particular requirements and situations, and the embodiment that best meets those requirements and situations may be chosen.

It may be appreciated that the rotor for the rotation sensor according to any of the embodiments may be used in conjunction with the rotation detecting sensor. The rotation detecting sensor 108 may be mounted outside the covering 6 along the axial direction so that it can be located close to the axial outer lateral side of the multi-pole magnet 10 that is enclosed by the covering 6.

The various preferred embodiments of the present invention have been described so far by referring to the drawings, and it may be appreciated that the components of the rotor for the rotation sensor, i.e., the reinforcing ring 2, the multi-pole magnet 10 and the covering 6, have the sandwich construction. The covering 6 is located on the axial outer lateral side of the multi-pole magnet 10, with the peripheral edge on its one end being secured to the reinforcing ring 2, and the multi-pole magnet 10 is held between covering 6 and the flanged part 4 of the reinforcing ring 2. Those components are thus combined together into a single unit.

The multi-pole magnet 10 is completely enclosed by the covering 6 on the axial outer lateral side thereof so that it can be isolated from the outside. Thus, the multi-pole magnet 10 can be protected against entry of any external solids or liquids such as lubricating oils that might otherwise damage or break the multi-pole magnet 10. Under such protected environment, it is ensured that the multi-pole magnet 10 can produce accurate and stable magnetic fields.

When the rotation detecting sensor 108 is placed under those accurate and stable magnetic fields, it can perform its high precision sensing functions, and can detect the number of revolutions with high precision.

Even in the embodiment in which the multi-pole magnet 10 is made of the elastic material such as rubber, it will not wear since it can be protected by the covering 6.

As the multi-pole magnet 10 is held fast by the covering 6 having the peripheral edge on its one end secured to the reinforcing ring 2 (sandwich construction), there is no risk that the multi-pole magnet 10 might be detached or slide during the actual operation. This ensures that the rotation detecting sensor can provide its rotation sensing functions over the long term.

### BRIEF DESCRIPTION OF THE DRAWINGS

FIG. 1 is a cross-sectional view of a rotor for a rotation sensor in accordance with a first embodiment of the present invention, and illustrates how it is mounted to a rotating part of a bearing, such as an inner race;

FIG. 2 is a cross-sectional view of the rotor for the rotation sensor in accordance with the present invention, and illustrates one example of a process in which a reinforcing ring and covering are secured together by means of a swaging method;

FIG. 3 is a cross-sectional view of the rotor for the rotation sensor in accordance with the present invention, and illustrates another example of the process in which its reinforcing ring and covering are secured together by means of another swaging method in an elastic manner;

FIG. 4 is a cross-sectional view of a rotor for a rotation sensor in accordance with a second embodiment of the present invention, and illustrates how it is mounted to parts of a bearing rotating relative to each other, such as an inner race and an outer race;

FIG. 5 is a cross-sectional view of a rotor for a rotation sensor in accordance with a third embodiment of the present invention, and illustrates how it is mounted to a rotating part of a bearing, such as an inner race in this case;

FIG. 6 is a cross-sectional view of a rotor for a rotation sensor in accordance with a fourth embodiment of the present invention, and illustrates how it is mounted to a rotating part of a bearing, such as an inner race in this case;

FIG. 7 is a cross-sectional view of a rotor for a rotation sensor in accordance with a fifth embodiment of the present invention, and illustrates how it is mounted to a rotating part of a bearing, such as an inner race in this case;

FIG. 8 is a cross-sectional view of a rotor for a rotation sensor in accordance with a sixth embodiment of the present invention, and illustrates how it is mounted to a rotating part of a bearing, such as an inner race in this case;

FIG. 9 is a cross-sectional view of a rotor for a rotation sensor in accordance with a seventh embodiment of the present invention, and illustrates how it is mounted to a rotating part of a bearing, such as an inner race in this case;

FIG. 10 is a partial cross-sectional view of a rotor for a rotation sensor in accordance with the present invention, and illustrates still another example of a process in which its reinforcing ring and covering are secured together by a swaging method;

FIG. 11 is a perspective view of a rotor for a rotation sensor in accordance with the present invention, and illustrates one end of a covering to be secured by means of swaging, with some parts being omitted;

FIG. 12 is a cross-sectional view of a rotor for a rotation sensor in accordance with the present invention, and illustrates how its components are assembled together; and

FIG. 13 is a cross-sectional view of a rotor for a rotation sensor in accordance with the prior art, and illustrates how it is mounted to the inner and outer races of bearing.

### BEST MODES OF EMBODYING THE INVENTION

Several preferred embodiments of the present invention are now described by referring to the accompanying drawings.

### First Embodiment

Before proceeding to the detailed description, preliminary steps are first described. The first step is to prepare a multi-pole magnet. In this step, NBR (acrylonitrile butadiene rubber) is provided, to which a ferrite magnetic powder (strontium ferrite powder) and a rubber chemical are added and mixed together. A rubber, which is still unvulcanized, is thus obtained, which contains 80% by weight of the strontium ferrite powder. Then, the unvulcanized rubber is placed into a mold where it is vulcanized and shaped into a ring. The ring is then magnetized to provide S poles and N poles such that each S pole and each N pole can appear alternately around its circumference. Finally, the multi-pole magnet 10 is thus obtained.

The second step is to prepare a covering. This covering 6 may be made of an SUS 304 plate of 0.5 mm thick, and includes a synthetic rubber lip 11 that is formed at one end 8 as shown in FIG. 1.

The third step is to prepare a reinforcing ring. This reinforcing ring 2 is made of metal, and is formed like an L-shape in cross section, including a cylindrical part 3 and a flanged part 4.

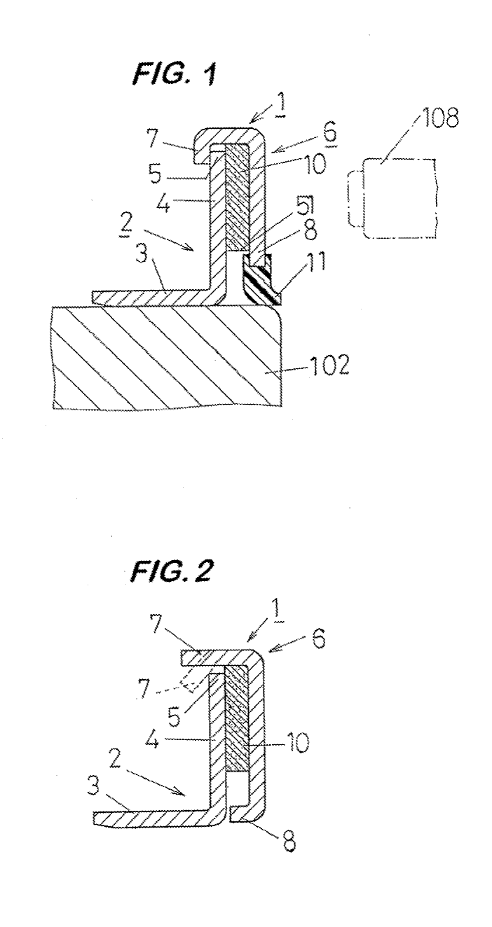

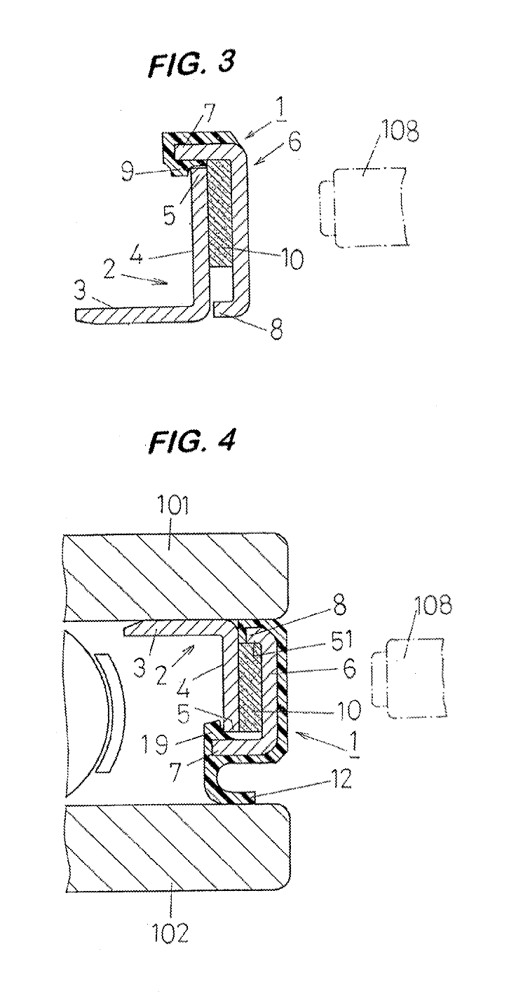

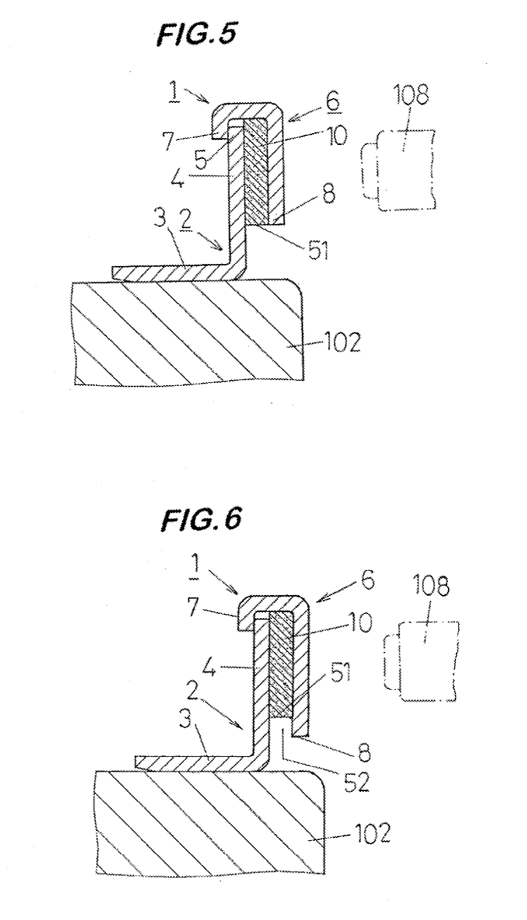

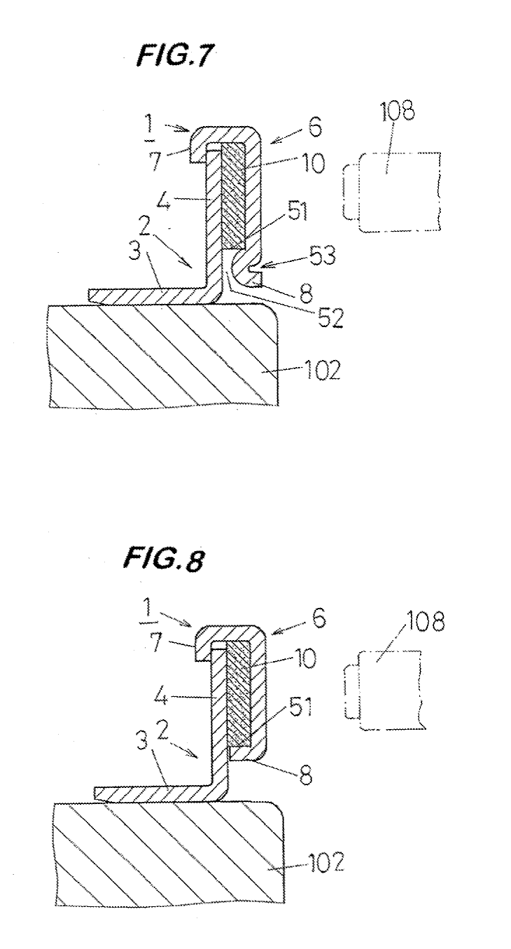

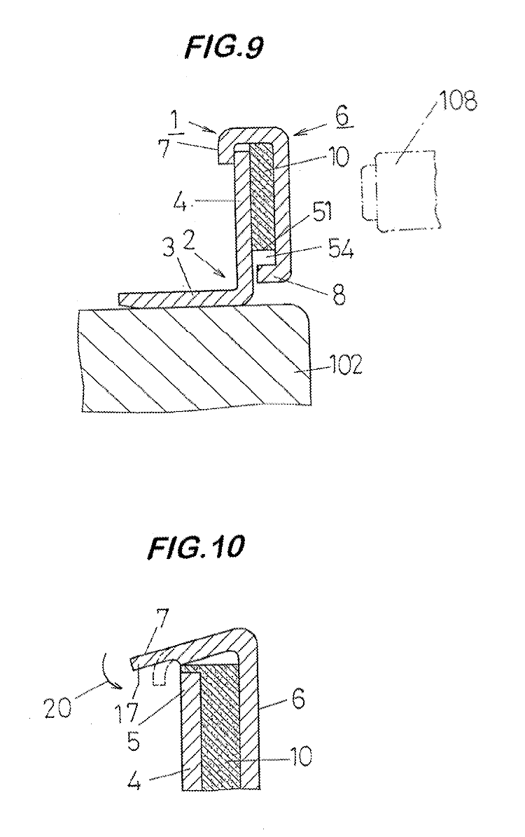

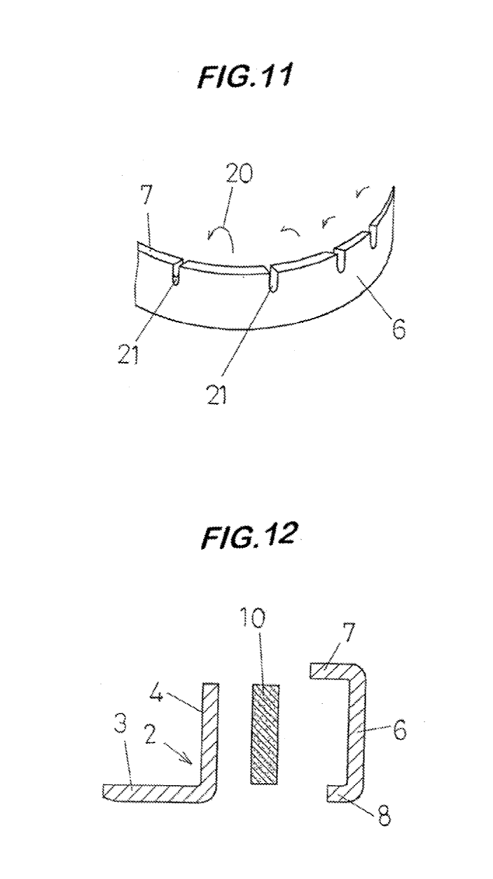

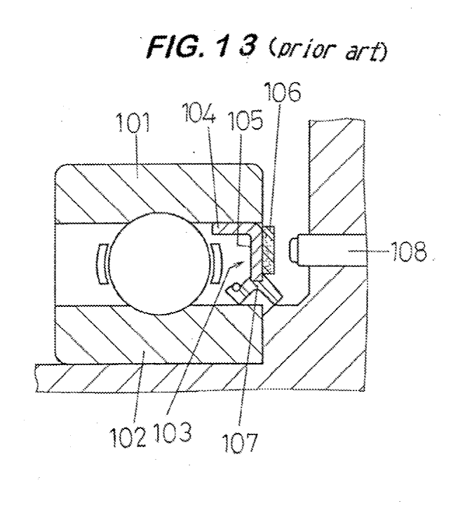

The multi-pole magnet 10, covering 6 and reinforcing ring 2 that have thus been obtained have the sandwich arrangement as shown in FIG. 12. Those three components may be assembled together in the following manner. For the covering 6, its marginal edge 7 may be partially deformed, as indicated by the dashed lines in FIG. 2. Then, the covering 6 may be secured to the reinforcing ring 2 by swaging the marginal edge 7. More specifically, the marginal edge 7 of the covering 6 may be secured to the radial peripheral edge 5 of the flanged part 4 of the reinforcing ring 2. This securing may be accomplished by swaging the marginal edge 7. The rotor for the rotation sensor according to the present invention, which is generally represented by 1, may thus be obtained. As seen from FIG. 1, the three components 2, 6 and 10 are combined together into a single unit, wherein the multi-pole magnet 10 is held between the reinforcing ring 2, or its flanged part 4, and the covering 6.

The rotor for the rotation sensor represented by numeral 1 may be mounted on a bearing that supports a wheel on an automotive vehicle, for example. More specifically, the cylindrical part 3 of the reinforcing ring 2 may be rigidly fitted on the peripheral surface of the rotating part of the bearing (which corresponds to the inner race 102 in the case shown in FIG. 1). When the rotor for the rotation sensor is actually used, a rotation detecting sensor 108 that is sensitive to pulses emitted by the rotor for the rotation sensor, or specifically, the multi-pole magnet 10, may be disposed close to the covering 6 such that the rotation detecting sensor 108 may be located on the side of the covering 6 facing opposite the axial outer lateral side of the multi-pole magnet 10.

When the rotor for the rotation sensor is mounted on the bearing as shown in FIG. 1, the tip of the synthetic rubber lip 11 may be made to engage the peripheral surface of the inner race 102 of the bearing so securely that the function of a fixed gasket can be provided.

### Second Embodiment

Before proceeding to the detailed description, preliminary steps are first described. The first step is to prepare a reinforcing ring. The reinforcing ring 2 is made of metal, and is formed like an L-shape in cross section, including a cylindrical part 3 and a flanged part 4. The flanged part 4 is then processed so that its outer lateral side (the right side in FIG. 12) may have preliminary base treatment. Following the preliminary base treatment, a coating of an adhesive may then be applied onto the outer lateral side. The second step is to prepare a multi-pole magnet. A rubber material in its unvulcanized state, from which the multi-pole magnet 10 may be formed, is first provided. The rubber material may contain H-NBR (hydrogen-added acrylonitrile butadiene rubber), a ferrite magnetic powder (strontium ferrite powder and barium ferrite powder), and a rubber chemical. In this case, the rubber material may preferably contain 85% by weight of the ferrite magnetic powder in relation to the rubber chemical. The rubber material thus obtained may be placed together with the reinforcing ring 2 onto a mold, where it may be vulcanized and shaped into a ring shape. The resulting vulcanized and shaped ring is combined with the reinforcing ring 2, in which the vulcanized and shaped ring is attached to the outer lateral side of the flanged part 4 of the reinforcing ring 2. The vulcanized and shaped ring may then be magnetized to provide S poles and N poles such that each S pole and each N pole can appear alternately around its circumference. The multi-pole magnet 10 is combined with the reinforcing ring 2, in which the multi-pole magnet 10 is attached to the outer lateral side of the flanged part 4 of the reinforcing ring 2.

The third step is to prepare a covering. The covering 6 may be made of a CuZn plate of 0.4 mm thick. Specifically, the plate may be formed into the shape of the covering 6 so that it has a marginal edge 7 facing the radial peripheral edge 5 of the flanged part 4 of the reinforcing ring 2. The marginal edge 7 includes a projection 19 and lip 12, both made of the synthetic rubber and formed circumferentially.

The reinforcing ring 2 and covering 6 thus obtained may be arranged in a manner such as shown in FIG. 12, and may then be assembled together. This assembling may be accomplished by forcing the radial peripheral edge 5 of the flanged part 4 of the reinforcing ring 2 into the synthetic rubber projection 19 formed circumferentially on the edge 7 of the covering 6. This provides the equivalent effect of the swaging process, whereby the peripheral edge of the covering 6 on its one end may be secured to the reinforcing ring 2 in an elastic manner, as shown in FIG. 4.

The rotor for the rotation sensor that includes the components described above according to the current embodiment of the present invention may be mounted on the bearing by fitting the cylindrical part 3 of the reinforcing ring 2 on the peripheral surface of the rotating part of the bearing (the outer race 101 in the case shown in FIG. 4). With the rotor for the rotation sensor being mounted on the bearing, the synthetic rubber lip 12 formed on the marginal edge 7 of the covering 6 may be made to engage the peripheral surface of the inner race 102 of the bearing in an elastic manner. Thus, a good sealing function may be provided.

It may be appreciated that, from the description provided above in connection with the embodiment shown in FIG. 4, the rotor for the rotation sensor includes the reinforcing ring 2, covering 6 and multi-pole magnet 10 that have the sandwich arrangement, wherein the multi-pole magnet 10 is held between the flanged part 4 of the reinforcing ring 2 and the covering 6 that secured in an elastic manner. This securing may provide the equivalent effect of the swaging process. Also, when the rotor for the rotation sensor is mounted on the bearing, the elastic rubber lip 12 may be made to engage the bearing slidably so that it may provide a good sealing function. The rotor may thus meet the requirements for a secure and sealed construction.

The rotor for the rotation sensor described in the first and second embodiments may be used in conjunction with the rotation detecting sensor 108. The rotation detecting sensor 108, which is shown in FIG. 13, for example, may be mounted from the outside axially, such that it can be located close to the axial outer lateral side of the multi-pole magnet 10 that is enclosed by the covering 6.

Although the present invention has been described in connection with the particular preferred embodiments thereof, it should be understood that the present invention is not limited to those embodiments, but various changes and modifications may be made without departing from the spirit and scope of the invention as defined in the appended claims.

What is claimed is:

1. A rotor for a rotation sensor that can be mounted on a bearing supporting a wheel on an automotive vehicle for detecting the number of revolutions of the wheel, said rotor comprising:
a reinforcing ring having an L-shape in cross-section, said reinforcing ring including a cylindrical part adapted to be fitted on a peripheral surface of a rotating part of the bearing and a flanged part that is bent at an end edge of said cylindrical part and from which said flanged part extends in a radial direction of said reinforcing ring;
a multi-pole magnet attached on an axially outer lateral side of said flanged part of said reinforcing ring; and
a covering made of non-magnetic material having a peripheral edge on one end thereof secured to said reinforcing ring and enclosing an axially outer lateral side of said multi-pole magnet;
wherein said covering is secured to said reinforcing ring by swaging; and
wherein said covering has a thickness in a range of between 0.1 mm and 0.6 mm.

2. The rotor of claim 1, wherein said covering is secured to said reinforcing ring by swaging by partly deforming one of a radial peripheral edge of said flanged part of said reinforcing ring and a marginal edge of said covering facing said radial peripheral edge of said flanged part of said reinforcing ring.

3. The rotor of claim 1, wherein said covering further comprises an elastic projection formed on a marginal edge of said covering facing a radial peripheral edge of said flanged part of said reinforcing ring, said covering is secured to said reinforcing ring by swaging by forcing said radial peripheral edge of said flanged part of said reinforcing ring into said elastic projection of said covering.

4. The rotor of claim 1, wherein said covering has an other end located opposite to said one end thereof which extends radially to and is terminated at a marginal edge of said multi-pole magnet closest to said cylindrical part.

5. The rotor of claim 1, wherein said covering has an other end located opposite to said one end thereof which extends radially beyond a marginal edge of said multi-pole magnet closest to said cylindrical part such that a gap is created between said other end of said covering and said axially outer lateral side of said flanged part.

6. The rotor of claim 1, wherein said covering has an other end located opposite to said one end thereof which extends radially beyond a marginal edge of said multi-pole magnet closest to said cylindrical part such that a gap is created between said other end of said covering and said axially outer lateral side of said flanged part and a bent portion is formed on said other end of said covering.

7. The rotor of claim 1, wherein said covering has an other end located opposite to said one end thereof which extends radially beyond a marginal edge of said multi-pole magnet closest to said cylindrical part and said other end of said covering is bent toward said flanged part of said reinforcing ring.

8. The rotor of claim 1, wherein said covering has an other end located opposite to said one end thereof which extends radially beyond a marginal edge of said multi-pole magnet closest to said cylindrical part, said other end of said covering has a bent portion bent toward said flanged part of said reinforcing ring, a gap is on said axially outer lateral side of said flanged part of said reinforcing ring that is delimited by said axially outer lateral side of said flanged part of said reinforcing ring, an end edge of said multi-pole magnet closest to said cylindrical part and said bent portion of said other end of said covering.

9. The rotor of claim 1, wherein said covering has an other end located opposite to said one end thereof which extends radially toward said cylindrical part beyond an end edge of said multi-pole magnet closest to said cylindrical part, said other end of said covering includes a lip extending radially from said other end of said covering, and said lip including a tip adapted to engage a peripheral surface of the bearing on which said cylindrical part of said reinforcing ring is adapted to be fitted.

10. The rotor of claim 1, wherein said covering has a lip on said one end thereof secured to said reinforcing ring, said lip extending radially from a marginal edge of said one end of said covering and having a tip adapted to engage a peripheral surface of the bearing on which said cylindrical part of said reinforcing ring is adapted to be fitted.

11. A rotation sensor that can be mounted on a bearing supporting a wheel on an automotive vehicle for detecting the number of revolutions of the wheel, comprising:
a rotor comprising:
a reinforcing ring having an L-shape in cross-section, said reinforcing ring including a cylindrical part adapted to be fitted on a peripheral surface of a rotating part of the bearing and a flanged part that is bent at an end edge of said cylindrical part and from which said flanged part extends in a radial direction of said reinforcing ring;
a multi-pole magnet attached on an axially outer lateral side of said flanged part of said reinforcing ring; and
a covering made of non-magnetic material having a peripheral edge on one end thereof secured to said reinforcing ring and enclosing an axially outer lateral side of said multi-pole magnet; and
a rotation detecting sensor mounted axially outside of said rotor and adjacent to said covering so as to face opposite said axially outer lateral side of said multi-pole magnet enclosed by said covering.

12. A rotor for a rotation sensor that can be mounted on a bearing supporting a wheel on an automotive vehicle for detecting the number of revolutions of the wheel, said rotor comprising:
a reinforcing ring including a cylindrical part adapted to be fitted on a peripheral surface of a rotating part of the bearing and a flanged part that is bent at an end edge of said cylindrical part and from which said flanged part extends in a radial direction of said reinforcing ring;
a multi-pole magnet attached on an axially outer lateral side of said flanged part of said reinforcing ring; and
a covering made of non-magnetic material having a peripheral edge on one end thereof secured to said reinforcing ring such that said reinforcing ring and said covering are fixed together with said multi-pole magnet between said reinforcing ring and said covering, and said covering enclosing an axially outer lateral side of said multi-pole magnet.
